(19) United States
(12) Patent Application Publication
(10) Pub. No.: US 2010/0104357 A1
(43) Pub. Date: Apr. 29, 2010

(54) Mechanical reinforcing bar coupler based on bar deformations

(76) Inventors: Al-Tuhami AbuZeid Al-Tuhami, (US); Soliman Soliman Ali Eldin, (US)

Correspondence Address: AL-TUHAMI, Al-Tuhami AbuZied, 9 Al-Husania Street, Al Husania 44519, Zagazig, EG

(21) Appl. No.: 11/599,491

(22) Filed: Nov. 6, 2006

Related U.S. Application Data
(62) Division of application No. PCT/EG05/00014, filed on May 14, 2005.

(51) Int. Cl. F16D 1/02

(52) U.S. Cl. 403/312; 403/310

(57) ABSTRACT

A mechanical coupler for the reinforcing bars depending on the original male deformations of the reinforcing bars. The coupler comprising a pipe split along its longitudinal axis into two portions. The inner surface of each portion is grooved to form female grooves that exactly matching the reinforcing bar male deformations. The coupler is formed of one or two halves of the pipe portion assembled over the ends of the axially aligned reinforcing bars allowing for the bars male deformations to exactly enter into the pipe portion female grooves without any clearance or filling material to be added. Five techniques are applicable to tightly close the sleeve over the connected reinforcing bars ends. The outer surface of the pipe portions is processed to be used according to the technique of closing either one or two pipe portions over the reinforcing bars ends. The coupler does not affect the effective cross-section area of the reinforcing bars as in case of threading or concentrate stresses at certain points at the bar ends, as in case of notching.

### TECHNICAL FIELD

The invention relates to a high tensile and compressive strengths mechanical reinforcing bars coupler based on bar deformations. The coupler does not affect the effective cross-sectional area of the reinforcing bars as in case of threading or concentrate stresses at certain points as in case of notching. The coupler as presented could allow for connecting reinforcing bars ends with different diameters.

### BACKGROUND ART

1—Lab Splice: It is the traditional technique used for decades and still used till now. The splice is made by lapping one of the reinforcing bars over the other with a suitable length sufficient to transmit the tension or the compression forces from the curtailed bar to the starting one. The length and specifications are determined according to the reinforcing bars ending position and its diameter.
2—Welding Splice: This method is used in reinforcing steel bars with diameters larger than 16 mm according to the steel grade weld-ability on condition of axial alignment of the welded bars and welding is done using electric arc. The welding length and thickness are determined according to the ultimate tension capacity of the welded bars (1 and 2). The welded connection (3) is made either by splicing the bars then welding, as shown in FIG. 1) or making the connection by welding the bar ends together then welding two additional bars (4) on the connection sides, as shown in FIG. 2).
3—Mechanical Splices:
   3-1—This splice is made in deformed reinforcing bars with diameter larger than 16 mm. In this case, a sleeve pipe (5) having adequate thickness with inner diameter equal to the reinforcing bars outer diameter is cold swaged on the two reinforcing bars ends (1 and 2), allowing for internally forming the inner surface of the sleeve pipe according to the reinforcing steel bar deformations, as shown in FIG. 3).
   3-2—Another mechanical splice is formed using internally threaded sleeves (6) along with externally threading both the connected reinforcing steel bar ends (1 and 2) applying different threading techniques. In one of these methods, heating and/or compressing the reinforcing bars ends to increase their diameter then threading the reinforcing bars ends. The splice is made by assembling the steel reinforcing bars with the internally threaded sleeve (6), as shown in FIG. 4).
   3-3—Another technique for mechanical splicing depends on making the connection from four parts and auxiliary assembling machine. The jaw assembly includes interior teeth (11) designed to bite into the projecting deformations (12) on the outside of the bar ends which form the overall diameter of the bar but not the core or nominal diameter of the bar. The jaw assembly is constricted from both axial ends by driving tapered locking collars (22) on each end of the jaw assembly with a tooth while concurrently causing the jaw assembly to constrict and bite into the bar ends. When the tool is removed, the collars remain in place locking the jaw assembly closed, as shown in FIG. 5).

Shortcomings and Drawbacks of the Background Art

The background art has the following shortcomings and problems:
1—The lab splice technique, which is the most widely used one, the two ends of the concrete reinforcing steel bars are placed parallel in lapping position with the required lap length. Both bars are tied together with thin steel wire, as previously explained, which may lead to the following problems:
   a. Wasting large amount of steel reinforcement, which is about 1 to 1.5 m for each bar splice.
   b. In concrete sections with large reinforcing steel percentage, the number of reinforcing steel bars is doubled leading to the possibility of blocking the whole concrete section and therefore honeycombing of the concrete section in a critical section of the structural member.
2—In coupler connections, which are performed by compressing the coupler with the reinforcing steel bars inside, the connection is mostly made before placing the reinforcing bars in the formwork resulting in very long steel bar with difficulty in handling. On the other hand, performing the coupler bar connection inside the formwork is rather difficult due to the limited accessibility and the difficulty in placing the used machinery inside the formwork.
3—In case of threading the inner surface of the coupler and the outer surface of the reinforcing steel bars, threading the bars is performed first outside the formwork because revolving the coupler will result in revolving the connected steel bar along its whole length. This process could not be performed in steel bars on their position inside the formwork due to the limited area and presence of other steel bars.
4—The connection formed of four parts, as previously mentioned, depend on biting the threads in the two jaws with the male deformations in the reinforcing steel bars needing high compression energy and a special machine, which could not also assembled inside the formwork. In addition, large coupler length is needed to assure generating sufficient resistance between the threads and the reinforcing steel bar male deformations.
5—In the method depending on placing the two steel bars to be connected inside part of a pipe with approximately circular cross-section, the inner diameter of that pipe is usually larger than the outer diameter of the reinforcing steel bar leading to unfavorable space inside the concrete section. In addition, the method needs large pipe length, large number of bolts increasing with increasing the bar diameter, leading to higher cost, and difficulty in handling and placing.
6—The difference between our patent application and that of the DE 1 659 247 A1:

The patent presented a clearance between the male deformations and the female grooves. This clearance is filled with a material in the plastic state to be hardened afterwards. One more thing, whatever the filler materials he adds, it will never have the same strength of the steel, meaning that the clearance will remain. In addition, the filler material will deform and crumble under higher tensile or compression loads, allowing for slippage to take place. No specification or description of that plastic material was presented and nothing grantee that there will be any bond between that material, the connected steel bars, and the coupler parts. The clearance between the steel bar deformations and the coupler in addition to the plastic filling material is presented in pages 2, 3, 4, and the claims of the original German patent.

Our patent application presents identical male deformations and female grooves having exactly and accurately the same dimensions, i.e., there is no clearance whatsoever between the male deformations and the female grooves.

No filling material is placed between the male deformations and the female grooves for two reasons, first, there is no clearance to add this material, second there is no need to put this material as both the male deformations and the female grooves are in full contact with each other.
7—The difference between our patent application and that of the U.S. Pat. No. 4,469,465:
   a—No female grooves are manufactured in the coupler sleeve.
   b—The female grooves are formed due to pressurizing the coupler by clamping force that results in forming these female grooves.
   c—The coupler sleeve material is softer than the reinforcing bars therefore, will give lower strength than the reinforcing bars, and consequently lower overall coupler strength.
   d—The side nuts are welded to the coupler halves, while in the fourth closure technique presented in our patent application the two coupler halves have originally manufactured protruded sides without welding these protruded parts with the coupler.
8—The difference between our patent application and that of the U.S. Pat. No. 5,967,691:
   a—Threading the steel bar ends which reduces the working cross-section of the steel bar, while there is no threading needed in our patent application.
   b—A friction welding process that results in annular extrusions is made near the steel bar end to form a stop for the coupler nut.
   c—The two coupler halves have threading, while those presented in our patent application we use female grooves that are exactly identical with the steel bar male deformations.
   The coupler presented in this patent is expensive, time consuming, need large machines for threading, need more manufacturing and assembly steps, and require great skill, while in our patent application is not required at all.

### DISCLOSURE OF THE INVENTION

The entire disclosure of Egyptian Patent Application No. 2004050224 filed on Jun. 17, 2004 including specifications, claims, drawings, and summary is incorporated herein by reference in its entirety.

This patent application includes the following new elements
1—A mechanical coupler for reinforcing bars depends on copying the reinforcing bar deformations on one or two halves of a pipe portion to form identical grooves (female) in the inner surface of the coupler. The coupler is made of steel or steel alloys by forging, casting, or rolling.
2—The one or two halves of a pipe portion are assembled along the ends of the two reinforcing bars to be connected assuring the coincidence of the reinforcing bars male deformations with the coupler or halves female grooves.
3—The one or two halves of the pipe portion are tightly closed on the two bar connection by a steel pipe or rings with inner diameter form a press fit with the outer diameter of the halves containing the steel bar connection, or by two pipes with inner conical shape pressed at the ends of the two halves or with rings or protruded rings as will be shown in the following.

Application of the Patent

A mechanical coupler for connecting the ends of two reinforcing bars is made of a sleeve divided into two halves split along its longitudinal axis. Each half is grooved (being a ‘female’) along its inner surface to match with the deformations ‘male’ on the reinforcing bars. The sleeve is adopted to connect the ends of the two ends of reinforcing bars in which the deformations of the reinforcing bars ‘male’ fitted into the grooves ‘female’ made in the inner surface of the sleeve. Four methods are available to tightly close the coupler two halves, as will be explained later.

Making the Connection
1—The outer diameter and thickness of the one or two halves of the pipe portion are chosen to be consistent with the reinforcing bars diameter to be connected (the coupler or sleeve inner diameter is equal to the reinforcing bars core diameter without accounting for the existing bar deformations).
2—The two ends of the reinforcing bars (1 and 2) to be connected are axially aligned with the male deformations (10) of the two bars enter the female grooves (16) made in the coupler inner surface (FIG. 7).
3—The two halves or half of the coupler or sleeve are tightly closed on the two bar ends (1 and 2) by one of the following four methods:
   a. The grooves (16) of the upper and lower halves of the sleeve (13 and 14) are fitted into the reinforcing bars male deformations (10) to grip the two bar ends together. A closure pipe (17) tightly grips the two sleeve halves (13 and 14) together with the inside bars ends (1 and 2) forming intermediate interference fit and achieving a specific pressure value that prevents the two bars from splitting, as shown in FIGS. (7), (8), and (9). (The coupler her mean the two sleeve halves and the closure pipe)
   b. As in FIGS. 10 and 11, the two halves of the sleeve (18 and 19) with its inside female grooves having an outer surface with gentle slope (20) directed towards the sleeve ends. The two sleeve halves (18 and 19) are assembled along the ends of the two reinforcing bars (1) and (2) to be connected assuring the coincidence of the reinforcing bars male deformations with the sleeve halves female grooves. However two tapered pipe locks (21) and (22) having internal diameter and slope identical to the external diameter and slope of said sleeve halves. The coupling is performed by entering the reinforcing bars male deformations into the said two sleeve halves female grooves then intruding the outer tapered locks (21) and (22) to close the ends of the assembled sleeve halves (18) and (19) and reinforcing bars (1) and (2). (The coupler in this section mean the two sleeve halves and the two tapered pipe locks)

In manufacturing the reinforcing steel bar deformations, the bar is subdivided into two sides left and right. The deformations made in the left portion of the bar are not necessarily coincide with that made in the right portion of that bar.

In addition, the two bars to be connected may have different shifts other than that of the first bar as shown in FIG. 12.a. The reason for that shifts originates from the manufacturing process of the steel reinforcement bars. The steel bar is rolled between two rollers. The female grooves of the two rollers are not always starting from the same point, resulting in that shift between the two sides of the deformations in r steel bar. In other words, the two sides of the steel bar deformations are not coincident depending on the two rollers starting points and may differ from manufacturing batch to another.

In an effort to overcome this difficulty, a other shape of coupler is develop depending on the deformations of one side only of the two reinforcing bars to be connected.
c. A pipe of steel or alloy is cut longitudinally to form a portion of a circle in its cross-section. The male deformations of the reinforcing bar ends are identically placed in the female grooves made in the pipe portion. The coupling of the two reinforcing bar ends is performed by intruding a number of outer rings having threaded holes 26 in FIGS. (12.b) over the assembled axially aligned two reinforcing bars ends and the portion of the cylindrical pipe 23. Then, the threaded bolts 25 are tightened in the threaded holes 26 over the reinforcing bars 1, 2 to complete the bar coupling process.
   Another form of the coupler that overcomes the problem of mail deformation shift shown in FIG. 12.a is introduced as follows:
d. A pipe half equipped with female grooves is used to connect the two reinforcing bars ends with the mail deformations coincident with female grooves. This pipe half has protruded rings allow for placing cylindrical steel packing 29 between them and the connected bar ends. Tightening threaded bolts in the threaded holes made in the upper rings will press the packing 29 in to the connected steel bars to give more uniform pressure distribution along the connected steel bars ends.
e. The fourth four techniques for tightly closing coupler over the reinforcing bars ends is comprised of the two sleeve halves 26 and 27 in FIGS. (13, 14 15 and 16). The outer cylindrical pipe 32 in FIGS. (15 and 16) or rings in FIGS. (13 and 14) with threaded holes having specific length, thickness, and an internal diameter. Flat or shallow spherical arcs 28 as in FIG. 14) are made to match the positions of the threaded holes 30 made in the cylindrical pipe or rings, both assembled by threaded bolts 31 in FIGS. (13, 14 15 and 16). The coupling is performed by exactly entering the two reinforcing bars ends male deformations into the two said sleeve halves female grooves, then intruding the outer cylindrical pipe 32 in FIGS. 15 and 16 or rings 29 in FIGS. (13) and (14) over assembled the axially aligned two reinforcing bars and sleeve halves. However, tightening the threaded bolts 31 in the threaded holes 30 over the flat portions or shallow spherical arcs 28 made in one of the sleeve halves to press the coupler halves that tightens the coupler halves over the two reinforcing steel bar ends.
   The threaded bolts 31 is characterized by having an end either flat or with shallow spherical arc that matches with flat portion or shallow spherical arc negatively made in one of the sleeve halves to form a contact area rather than contact point as shown in FIG. 13 detail B, and to restrict the threaded bolt movement during tightening.

Manufacturing the One or Two Halves of the Pipe Portion:

A suitable steel alloy or cast steel is chosen to manufacture the coupler or the sleeve by forming it in dimensions suitable for the mechanical coupler and according to the required shape. The coupler is made either by forging, casting, or rolling using either one of the following methods:

1: Forging or Casting:

In case of manufacturing the coupler by forging or casting, a special mould to form the coupler internally and externally is forged considering the choice of the alloy suitable for each case. The coupler outer surface is processed first according to the closure type of the coupler over the connected bars. Noting that, these two methods are suitable for the methods or coupler assembly presented in the four methods of part 3 of making the connection.

2: Rolling:

In manufacturing the coupler using rolling, a suitable steel alloy is rolled in suitable dimensions over rollers having male deformations exactly the same as those of the reinforcing bars to be connected forming female grooves in the rolled sections. These sections are cut with suitable lengths accounting for the grooves direction in the coupler halves. (Note: the direction of the grooves in the coupler two halves is an exact image of the male deformations in the reinforcing bars). The outer surface of the coupler is processed according to the method of closing the coupler halves over the reinforcing bars ends. Noting that this method is suitable only for the method of assembly explained in paragraphs (a) and (b) in item (3) of making the connection.

FIGS. (7), (8) and (9) shows the two reinforcing bars ends (1) and (2) to be connected by the sleeve halves (13) and (14), whereas the female grooves (16) formed in the two sleeve halves are assembled to form a pipe with internal diameter equals to the outer diameter of the reinforcing bars without the deformations. The protruded end of the coupler (15) is used as stoppage of the cylindrical pipe (17) having specific thickness and internal diameter slightly less than the outer diameter of the coupler two halves with the reinforcing bars ends inside the coupler.

The two halves of the sleeve (13) and (14) with the reinforcing bars ends (1) and (2) inside them are tightly closed by entering the pipe (17). Knowing that the pipe inner diameter is slightly less than the outer diameter of the coupler with the reinforcing bars ends inside to form specific internal compression capable of preventing the two reinforcing bars ends from splitting.

The connection shape shown in FIGS. (10) and (11) is resembling that shown in FIG. (7) except for the two sleeve halves (18) and (19) are tapered with gentle slope (20) towards the sleeve ends forming two partial cone at the sleeve ends. The coupler is tightly closed over the two reinforcing bars ends through matching the reinforcing bars male deformations with the sleeve female grooves. An outer tapered pipe locks (21) and (22), having an inner slope matching the original coupler external slope (20), is entered at the first coupler ends with specific axial force achieving pressure that prevents the two reinforcing bars ends from splitting.

Manufacturing and Assembly of the Coupler:
a. A sleeve is chosen as a pipe with internal diameter that equals to the core diameter of the reinforcing bars to be connected without accounting for the reinforcing bars male deformations. The pipe thickness (the solid part between the internal and external diameters of the pipe) is chosen to be proportional to the reinforcing bars diameters.
b. The pipe is split into two halves along its longitudinal axis.
c. In case of using forging in copying the reinforcing bars male deformations into the sleeve or coupler halves, the coupler portions need to be heated, and then the male deformations are copied in the inner surface of the two coupler or sleeve halves. In case of making the coupler or sleeve halves using rolling, every portion of the coupler is heated and rolled by the roller having male deformations exactly matching the male deformations of the reinforcing bars to form female grooves in the coupler. Noting that the direction of the female grooves made in the upper half of the coupler or sleeve opposite to the direction of the female grooves made in the lower portion of the coupler or sleeve. The couplers portions are then cut at the designed lengths, so that connecting each two coupler portions on the reinforcing bars will from the required coupler.
d. A suitable steel material having suitable dimensions is rolled over rollers to finally form a continuous section having the shape of a coupler with internal female grooves identical to the male deformations of the reinforcing bars to be connected. This long section is then cut into couplers of suitable lengths accounting for the directions of the female deformations in the coupler interior. Outer surface slopes are also made as previously described in the third method of assembly.

Coupler Closure Techniques:

First Coupler Closure Technique

a. The two reinforcing bars to be connected are axially aligned, then the two sleeve halves are assembled around the reinforcing bars ends by matching the bar male deformations with the coupler female grooves.

b. A special pipe is prepared having an interior diameter equal to the outside diameter of the two sleeve halves with the two reinforcing bars ends inside them and also having a suitable thickness.

c. The pipe is intruded by compression into the sleeve halves with the connected reinforcing bars inside them.

Second Closure Technique

The connection shape shown in FIGS. (10) and (11) is resembled as that shown in FIG. (7) except for the two sleeve halves (18) and (19) are tapered with gentle slope (20) towards the sleeve ends forming two partial cones at the sleeve ends. The coupler is tightly closed over the two reinforcing bars ends through matching the reinforcing bars male deformations with the sleeve female grooves. An outer tapered pipe locks (21) and (22), having an inner slope matching the original sleeve external slope (20), is entered from the two sleeve ends with specific axial force achieving pressure that prevents the two reinforcing bars ends from splitting.

Third Closure Technique

A pipe of steel or alloy is cut longitudinally to form a portion of a circle in its cross-section. The male deformations of the reinforcing bar ends are identically placed in the female grooves made in the pipe portion. The coupling of the two reinforcing bar ends is performed by intruding a number of outer rings having threaded holes 26 in FIG. (12.b) over the assembled axially aligned two reinforcing bars ends and the portion of the cylindrical pipe 23. Then, the threaded bolts 25 are tightened in the threaded holes 26 over the reinforcing bars 1, 2 to complete the bar coupling process.

Fourth Closure Technique

Another form of the coupler that overcomes the problem of mail deformation shift shown in FIG. 12.a is introduced as follows:

b. A pipe half equipped with female grooves is used to connect the two reinforcing bars ends with the mail deformations coincident with female grooves. This pipe half has protruded rings allow for placing cylindrical steel packing 29 between them and the connected bar ends. Tightening threaded bolts in the threaded holes made in the upper rings will press the packing 29 in to the connected steel bars to give more uniform pressure distribution along the connected steel bars ends.

Fifth Closure Technique

The fourth four techniques for tightly closing coupler over the reinforcing bars ends is comprised of the two sleeve halves 26 and 27 in FIGS. (13, 14 15 and 16). The outer cylindrical pipe 32 in FIGS. (15 and 16) or rings in FIGS. (13 and 14) with threaded holes having specific length, thickness, and an internal diameter. Flat or shallow spherical arcs 28 as in FIG. (14) are made to match the positions of the threaded holes 30 made in the cylindrical pipe or rings, both assembled by threaded bolts 31 in FIGS. (13, 14 15 and 16). The coupling is performed by exactly entering the two reinforcing bars ends male deformations into the two said sleeve halves female grooves, then intruding the outer cylindrical pipe 32 in FIGS. 15 and 16 or rings 29 in FIGS. (13) and (14) over assembled the axially aligned two reinforcing bars and sleeve halves. However, tightening the threaded bolts 31 in the threaded holes 30 over the flat portions or shallow spherical arcs 28 made in one of the sleeve halves to press the coupler halves that tightens the coupler halves over the two reinforcing steel bar ends.

The threaded bolts 31 is characterized by having an end either flat or with shallow spherical arc that matches with flat portion or shallow spherical arc negatively made in one of the sleeve halves to form a contact area rather than contact point as shown in FIG. 13 detail B, and to restrict the threaded bolt movement during tightening.

According to the present invention, there provided couplers for connecting the ends of reinforcing bars ends, comprising:
1 Reinforcing steel bar 1.
2 Reinforcing steel bar 2.
3 Welding of Reinforcing steel bar 1 to Reinforcing steel bar 2.
4 Additional portion of reinforcing steel bar.
5 Cold swaged sleeve coupler.
6 Internally threaded collar.
7 Two contractible jaws.
8 Threaded pin bolt.
9 Lock.
10 Deformation.
11 Interior teeth.
12 Projecting deformation.
13 Upper half of internally grooved sleeve with protruded end.
14 Lower half of internally grooved sleeve with protruded end.
15 Protruded sleeve end (lip).
16 Female grooves.
17 Closure pipe.
18 Upper half of internally grooved sleeve with tapered ends.
19 Lower half of internally grooved sleeve with tapered ends.
20 Inclination of the tapered sleeve.
21 Right tapered sleeve lock.
22 Left tapered sleeve lock.
23 A portion of internally grooved cylindrical pipe
24 An internally grooved pipe half with upper protruded rings.
25 cylindrical steel Packing.
26 Upper half of internally grooved sleeve without protruded or tapered ends.
27 Lower half of internally grooved sleeve without protruded or tapered ends.
28 Shallow spherical arc.
29 Rings with threaded holes.
30 Threaded holes.
31 Threaded bolts.
32 Cylindrical pipe with threaded holes.
33 Shift between the right and left bar deformation
34 Shift equal to zero
35 Pitch between two bar deformations

### DRAWING FIGURES

FIG. 1 Splicing the two reinforcing bars then welding.

FIG. 2 Welding the bar ends together then welding two additional bars on the connection sides.

FIG. 3 Cold swaged sleeve coupler.

FIG. 4 Coupler based on internally threaded sleeves and externally threaded reinforcing bars.

FIG. 5 Two jaw assembly includes interior teeth biting into the deformations of steel bars.

FIG. 7 Section of the coupler with the first coupler closure technique.

FIG. 8 Isometric view of a sleeve half having the internal female grooves.

FIG. 9 Exploded view of the coupler with its first closure technique.

FIG. 10 Section of the coupler with the second coupler closure technique.

FIG. 11 Isometric view of the coupler with its second closure technique.

FIG. 12 The coupler with one portion of internally grooved cylindrical pipe.

FIG. 13 Section of the coupler with the fourth coupler closure technique ring type.

FIG. 14 Isometric view of the coupler with its fourth closure technique ring type.

FIG. 15 Section of the coupler with the fourth coupler closure technique cylindrical pipe type.

FIG. 16 Isometric view of the coupler with its fourth closure technique cylindrical pipe type.

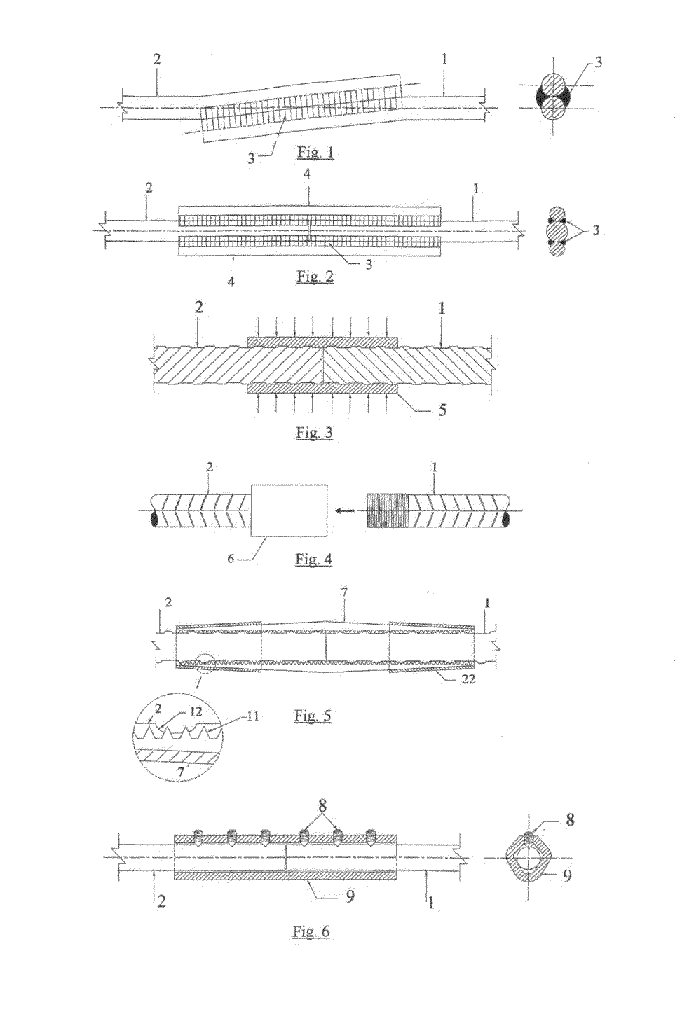

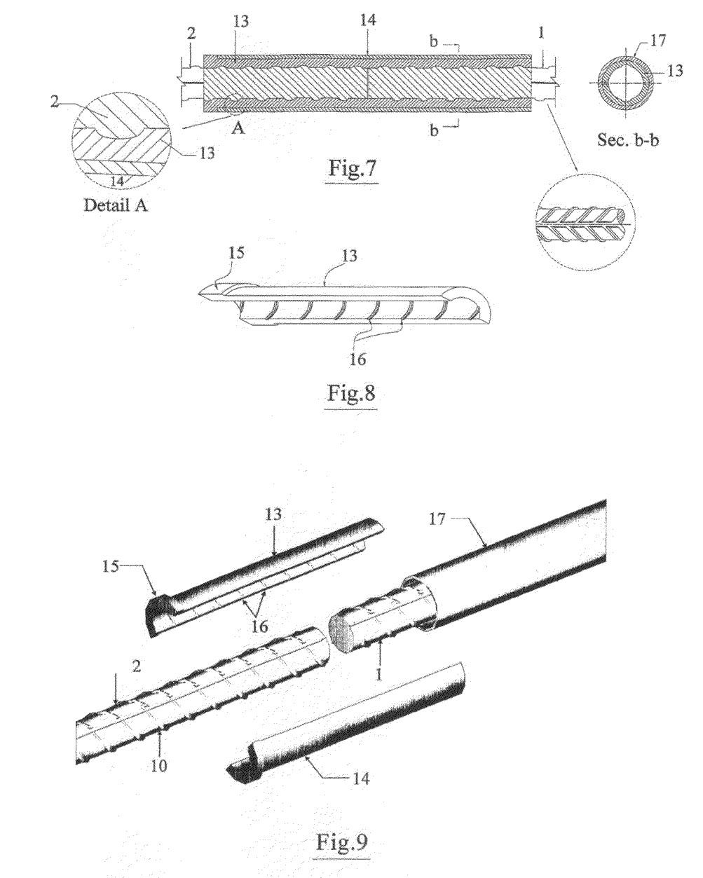

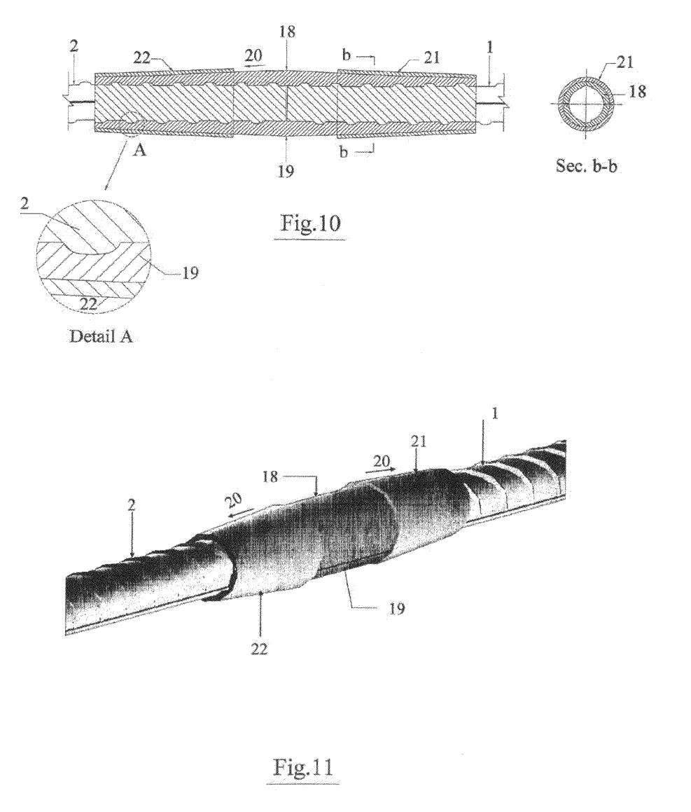

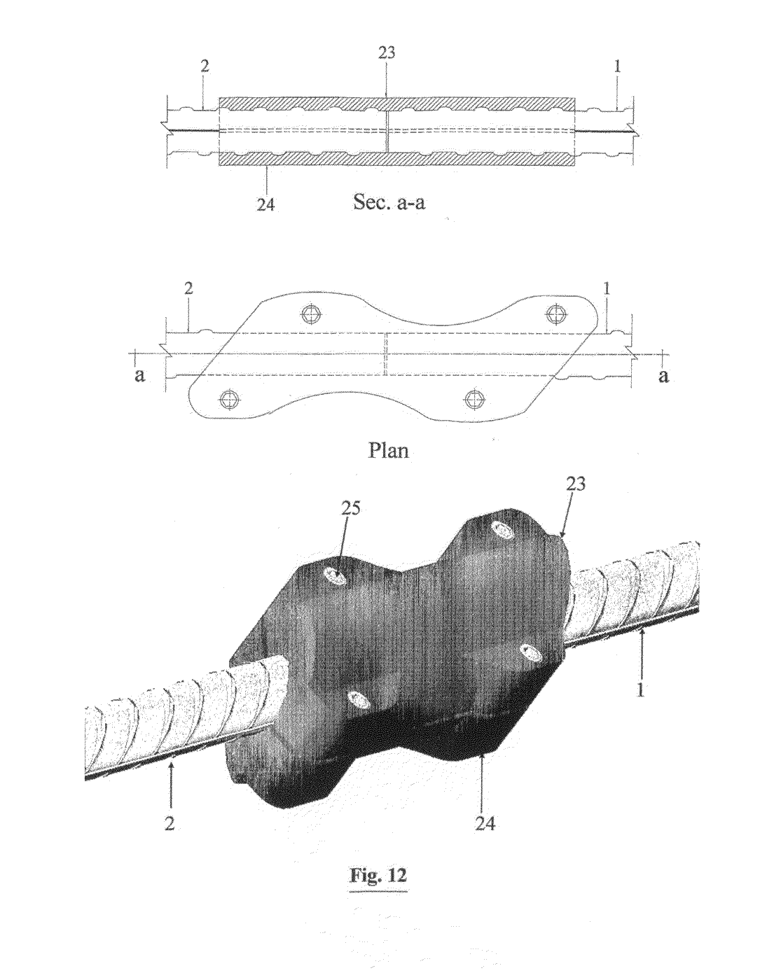

### INDUSTRIAL APPLICATION OF THE INVENTION

The patent could be sold to reinforcing steel manufacturing companies or a special factory could be erected to produce the coupler achieving the required quality and specifications for each reinforcing bars diameter accounting for the differences between the steel reinforcing bars produced by different factories, according to the following:

### Methods

a. The outer diameter of the pipe used in manufacturing the coupler is chosen with an internal diameter equal to the reinforcing bar to be connected, noting that the coupler internal diameter is equal to the straight diameter of the reinforcing bar and not the deformation diameter. The thickness (the solid part between the internal and external diameters of the coupler) is proportional to the reinforcing bars diameter.
   The pipe is split into two equal halves along its longitudinal direction.
   In case of suing forging or casing to manufacture the coupler, a special mould is made to form the required internal and external shapes of the coupler, using the steel alloy suitable for each case.
b. The connection shape shown in FIGS. (10) and (11) is resembled as that shown in FIG. (7) except for the two sleeve halves (18) and (19) are tapered with gentle slope (20) towards the sleeve ends forming two partial cones at the sleeve ends. The coupler is tightly closed over the two reinforcing bars ends through matching the reinforcing bars male deformations with the sleeve female grooves. An outer tapered pipe locks (21) and (22), having an inner slope matching the original sleeve external slope (20), is entered from the two sleeve ends with specific axial force achieving pressure that prevents the two reinforcing bars ends from splitting.
d. The fourth techniques for tightly closing coupler over the reinforcing bars ends is comprised of the two sleeve halves 26 and 27 in FIGS. 13, 14 15 and 16). The outer cylindrical pipe 32 in FIGS. (15 and 16) or rings with threaded holes having specific length, thickness, and an internal diameter. Flat or shallow spherical arcs 28 as in FIG. (14) are made to match the positions of the threaded holes 30 made in the cylindrical pipe or rings, both assembled by threaded bolts 31. The coupling is performed by exactly entering the two reinforcing bars ends male deformations into the two said sleeve halves female grooves, then intruding the outer cylindrical pipe 32 in FIGS. 15 and 16 or rings 29 in FIGS. (13) and (14) over assembled the axially aligned two reinforcing bars and sleeve halves. However, tightening the threaded bolts 31 in the threaded holes 30 over the flat portions or shallow spherical arcs 28 made in one of the sleeve halves to press the coupler halves that tightens the coupler halves over the two reinforcing steel bar ends. The threaded bolts 31 is characterized by having an end either flat or with shallow spherical arc that matches with flat portion or shallow spherical arc negatively made in one of the sleeve halves to form a contact area rather than contact point as shown in FIG. 13 detail B, and to restrict the threaded bolt movement during tightening.

1- A mechanical coupler for the reinforcing bars depending on the original male deformations of the reinforcing bars comprising a pipe split along its longitudinal axis into two portions, the inner surface of each portion is grooved to form female grooves that exactly matching the reinforcing bar male deformations, the coupler is formed of one or two halves of the pipe portion assembled over the ends of the axially aligned reinforcing bars allowing for the bars male deformations to exactly enter into the pipe portion female grooves without any clearance or filling material to be added, five techniques are applicable to tightly close the sleeve over the connected reinforcing bars ends, the outer surface of the pipe portions is processed to be used according to the technique of closing either one or two pipe portions over the reinforcing bars ends, the coupler does not affect the effective cross-section area of the reinforcing bars as in case of threading or concentrate stresses at certain points at the bar ends, as in case of notching.

2- The said coupler as presented in claim (1) is made of alloy with suitable strength, having an external diameter and thickness proportional to the said reinforcing bars and an internal diameter equal to the diameter of the said reinforcing bars without accounting for the said male deformations.

3- The said one or two halves of the pipe portion as presented in claim (1) with its said internal female grooves is manufactured either by forging, casting, or rolling, to give exactly the same profile as that of the said reinforcing steel bar male deformations without any clearance between the male deformations and the female grooves during or after the coupler assembly process.

4- The said coupler as presented in claim (1) could allow for connecting two different reinforcing bars diameters.

5- Manufacturing the said one or two halves of the pipe portion (sleeve or said coupler) as presented in claim (3) by either forging or casting requires making a special mould to form the said sleeve internally and externally with the required dimensions.

6- Manufacturing the said one or two halves of the pipe portion by rolling as presented in claim (3) is made by rolling a suitable alloy with suitable dimensions over rollers having male deformations exactly the same as those of the said reinforcing bar deformations to be connected, to form a continuous section having the shape of the said sleeve half with said female grooves with exactly the same profile of the said reinforcing bar male deformations, and to be cut with suitable lengths accounting for the direction of the female grooves in each said sleeve half.

7- The first of said four techniques for tightly closing said one or two halves of the pipe, portion over the said reinforcing bars ends as presented in claim (1) is comprised of the two said two halves of the pipe portion and an outer cylindrical pipe having specific length and an internal diameter slightly less than the outer diameter of the two said one or two halves of the pipe portion, the coupling is performed by entering the said reinforcing bars ends male deformations into the said two halves of the pipe portion female grooves processed to match the said male deformations without any clearance, then intruding said outer cylindrical pipe over assembled said two reinforcing bars and said two halves of the pipe portion achieving pressure sufficient to prevent the two connected reinforcing bars from splitting, without any need for friction welding, annular extrusions, or threading the said reinforcing steel bars.

8- The second of said four techniques for tightly closing coupler over the said reinforcing bars ends as presented in claim (1) is comprised of the said two halves of the pipe portion with said female grooves having an outer surface with gentle slope directed towards the said two halves of the pipe portion ends and two tapered pipe locks having internal diameter and slope identical to the external diameter and slope of said two halves of the pipe portion, the coupling is performed by entering the said reinforcing bars male deformations into the said two halves of the pipe portion female grooves processed to match the said male deformations without any clearance, then intruding the outer tapered locks to close the ends of the assembled said sleeve halves and said reinforcing bars.

9- The third of the said four techniques for tightly closing said one half of the pipe portion over the said reinforcing bars ends as presented in claim (1) is comprised of a pipe of steel or alloy cut longitudinally to form a portion of a circle in its cross-section, the coupling of the said two reinforcing bar ends is performed by intruding a number of outer rings having threaded holes over the assembled axially aligned said two reinforcing bars ends and the said one portion of the cylindrical pipe, then, threaded bolts are tightened in the said threaded holes over the said reinforcing bars to complete the bar coupling process.

10- The fourth of the said five techniques for tightly closing said one half of the pipe portion over the said reinforcing bars ends as presented in claim (1) is comprised of the said pipe half with said female grooves, the said pipe half has protruded upper rings with specific length, thickness, and an internal diameter that allows for placing cylindrical steel packing between the said protruded upper rings and the said reinforcing bar ends to be connected, then tightening the threaded bolts in the threaded holes over the said cylindrical steel packing to press the said one half of the pipe portion over the said two reinforcing steel bar ends.

11- The fifth of said four techniques for tightly closing said coupler over the said reinforcing bars ends as presented in claim (1) is comprised of the said two halves of the pipe portion and an outer cylindrical pipe or rings with threaded holes having specific length, thickness, and an internal diameter slightly less than the outer diameter of the said two halves of the pipe portion in which flat or shallow spherical arcs are made to match the positions of the threaded holes made in the cylindrical pipe or rings, both assembled by threaded bolts, the coupling is performed by entering the said reinforcing bars ends male deformations into the said two halves of the pipe portions female grooves, then intruding said outer cylindrical pipe or rings over assembled said two reinforcing bars and said two halves of the pipe portions, then tightening the threaded bolts in the threaded holes over the flat portions or shallow spherical arcs made in one of the said two halves of the pipe portions to press the two halves of the pipe portions over the said two reinforcing steel bar ends.

12- The said threaded bolt presented in claim (10) is characterized by having an end either flat or with shallow spherical arc that matches with flat portion or shallow spherical arc negatively made in one of the sleeve halves to form a contact area rather than contact point, and to restrict the threaded bolt movement during tightening.
